(19) United States
(12) Patent Application Publication
(10) Pub. No.: US 2014/0067479 A1
(43) Pub. Date: Mar. 6, 2014

(54) AUTOMATED FEATURE-BASED ANALYSIS FOR COST MANAGEMENT OF DIRECT MATERIALS

(71) Applicant: Akoya, Inc., Indianapolis, IN (US)

(72) Inventors: J. Alan Stacklin, Naperville, IL (US); James Taylor, Steinkjer (NO); Karen Caswelch, Indianapolis, IN (US); Ryan Stacklin, Chicago, IL (US)

(73) Assignee: Akoya, Inc., Indianapolis, IN (US)

(21) Appl. No.: 14/010,969

(22) Filed: Aug. 27, 2013

Related U.S. Application Data
(60) Provisional application No. 61/693,619, filed on Aug. 27, 2012.

(51) Int. Cl. G06Q 30/02

(52) U.S. Cl. CPC G06Q 30/0206
USPC 705/7.35

(57) ABSTRACT

A computerized method, system, and computer-readable medium of automated feature-based analysis for cost management of direct materials is disclosed. The method includes receiving a plurality of suppliers and at least one part offered by each of the plurality of suppliers, determining, with a processor, a should cost for each of the at least one parts based at least in part on features characteristics information, financial information, and purchasing demand information, receiving a request to compare the should cost for each of the at least one parts with a vendor price provided by a first supplier, wherein the first supplier is one of the plurality of suppliers, determining, with a processor, a spend index and fit score for each of the at least one parts offered by the first supplier, and automatically displaying a comparison of the spend index and fit score for each of the at least one parts offered by the first supplier through a graphical user interface.

### CROSS REFERENCE TO RELATED APPLICATIONS

This application also claims the benefit of and incorporates by reference herein the disclosure of U.S. Ser. No. 61/693,619, filed Aug. 27, 2012.

### BACKGROUND

Commercial producers of equipment, machines, and other products that require numerous parts often obtain their parts from a variety of different part suppliers. It is crucial to the survival of each producer's business that their suppliers be able to consistently provide the parts at an acceptable price. Because of this reliance, it comes as no surprise that information regarding the vulnerability and cost effectiveness of a parts supplier is extremely valuable. In the past, producers have depended upon their personal relationships with the parts suppliers and discussions with others in the industry to determine the level of vulnerability and cost effectiveness of a particular part supplier. While this word-of-mouth system may have been helpful in some limited circumstances, the world-wide nature of parts supply today makes such a system unworkable. Besides, such a system largely depends on the trust of other individuals who may have a motivation to bend the truth to their advantage. Thus, the system itself is inherently flawed. Accordingly, there exists a need for a system, method, and computer-readable program that allows producers to manage the cost and supply of parts.

### BRIEF DESCRIPTION OF THE DRAWINGS

FIG. 1 illustrates a flowchart of a system for automated feature-based analysis for cost management of direct materials according to at least one embodiment of the present disclosure;

FIGS. 2a-d show process modeling diagrams according to at least one embodiment of the present disclosure;

FIG. 2e shows an assembly of FIGS. 2a-d according to at least one embodiment of the present disclosure;

FIG. 3A shows a flowchart illustrating the analytics layer of the system according to at least one embodiment of the present disclosure;

FIG. 3B illustrates a method of sourcing analysis according to one embodiment of the present disclosure;

FIG. 3C illustrates the system architecture according to at least one embodiment of the present disclosure;

FIG. 3D illustrates the logical flow of the business intelligence layer according to at least one embodiment of the present disclosure;

FIG. 4 illustrates exemplary computations performed by the analytics layer according to at least one embodiment of the present disclosure;

FIG. 5 illustrates a graphical user interface of the system showing the results of the sourcing analysis according to at least one embodiment of the present disclosure;

FIGS. 6-30 illustrate graphical user interfaces according to various embodiments of the present disclosure.

### SUMMARY OF THE INVENTION

A cost management system and method using an automated features-based system and process for analyzing costs of direct, made-to-order parts is described herein. More particularly, the system employs proprietary algorithms to analyze features of target parts including their material, shape, as well as other characteristics and estimate what such parts should cost to produce. By comparing the “should costs” with vendors' prices for parts, the system automatically identifies cost savings opportunities. In at least one embodiment of the present disclosure, the system utilizes information in CAD files and other drawings to analyze key features and manufacturing characteristics of selected components and identifies cost relationships. The system can use these identified relationships to identify outliers, namely parts that appear to be unusually expensive compared with what the system predicts that they should cost. Such parts can be further analyzed by the user to determine if they are candidates for cost reduction. In at least one embodiment of the present disclosure, the system performs four primary calculations. First, based on part features, materials, manufacturing processes, and purchasing demand volumes, the system calculates a “should cost” price for each part and identifies outlier parts by comparing the “should cost” with the vendor's quoted price. For users of the system, parts sold to the user that are currently priced above the “should cost” may present a good opportunity for the user to reduce cost by finding a new supplier or asking the current supplier to reduce the price of the parts. Second, the system identifies key factors called “cost drivers,” which contribute to part costs. These key factors can be used by the engineering staff to minimize cost in the design process. Third, the system identifies similar parts called “nearest neighbors.” Last, the system analyzes the capabilities of the suppliers to identify their core capabilities and thereby determines which parts are most efficiently sourced by each respective supplier. The system uses a top-down approach that can analyze an enterprise-wide set of data on purchased direct materials, automatically identify “sweet spots” that have the most cost reduction potential, and provide direction on how to attain cost savings.

In at least one embodiment of the present disclosure, large amounts of data can be processed through the system to accurately pinpoint the specific opportunities that will give the most impact and efficiency in reducing costs. Such a system can serve as the next generation of cost management tools that work in conjunction with existing cost management methods to accurately identify specific parts that are candidates for cost reduction and to steer the process used to obtain cost savings. Such a system can also serve as a cost management tool for evaluating current and potential suppliers.

### DETAILED DESCRIPTION

A cost management system and method using an automated feature-based system and process for analyzing costs of parts and suppliers thereof is described herein. The cost management system may include a computer readable medium for storing information in one or more fields and a microprocessor that is coupled to the computer readable medium. The microprocessor may be programmed with instructions for manipulating the information. The cost management system may also include a display screen that is coupled to the computer readable medium. The display screen may be configured to display the information to a user of the cost management system and to permit selection of the one or more fields by the user. The cost management system may further include one or more software processes stored on the computer readable medium where such processes may be executed on the microprocessor. One or more of these software processes may allow a user to provide information to the cost management system, wherein such information may include one or more of features characteristics information of the target part, financial information related to the target part and purchasing demand information related to the target part. Moreover, one or more additional software processes may analyze the features characteristics information, the financial information, and the purchasing demand information and to determine a should cost of the target part (“target part should cost”) and to compare the target part should cost to a supplier's price of the target part to determine cost saving opportunities. One or more software processes may analyze and compare current and prospective suppliers. One or more software processes may display graphs, charts, and the like to display part and supplier information. This detailed description is presented in terms of programs, data structures or procedures executed on a computer or network of computers. The software programs implemented by the system may be written in languages such as Java, HTML, Python, or the R statistical language. However, one of skill in the art will appreciate that other languages may be used instead, or in combination with the foregoing.

For purposes of illustration, the present disclosure relates to a system, method, and software product directed to cost management of highly engineered made-to-order parts. In one embodiment of the present disclosure, the system receives or obtains data from computer assisted drawings (CAD) files, engineering specifications files, demand data from Enterprise Resource Planning (ERP) systems, pricing data from financial systems, and/or other electronic files and utilizes data mining algorithms to analyze part features, usage patterns, and engineering specifications to construct “should cost” curves across entire categories of parts. Based on the should cost curves, the system determines the significant cost drivers that affect the cost of the one or more target parts. In at least one embodiment of the present disclosure, the system analyzes the data to compare current and prospective suppliers of parts.

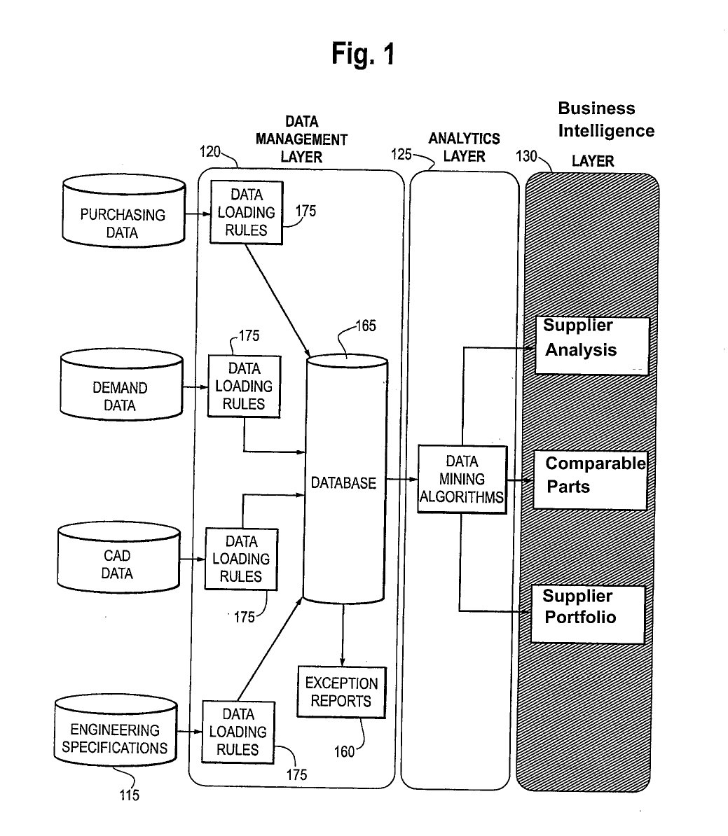

As shown in FIG. 1, in one embodiment of the present disclosure, the system architecture consists of three distinct layers: the data management layer 120, the analytics layer 125, and the business intelligence layer 130. The data management layer 120 in the system architecture loads and manages customer data. The middle layer in the architecture is the analytics layer 125, which hosts various analysis algorithms that are required for invention models. The business intelligence layer 130 of the system architecture presents results in easy to understand and act-upon Business Intelligence Tools. In one embodiment of the present disclosure, the Business Intelligence Tools are presented to the user in a browser interface or tablet application.

### I. System Data Management Layer

In one embodiment of the present disclosure, the data management layer 120 of the system consists of five parts. First, the system implements integration points that enable it to assimilate purchasing, financial, and part features information from the customer's internal systems. The system uses data loading rules 175 (from the integration points) as part of its data assimilation process. The data loading rules 175 may be needed because often each customer stores its parts purchasing and financial data using different formats. The data loading rules 175 aggregate data for various customers and thereby enable the system to employ a business intelligence “should cost” database 165 that is reusable across customers.

The part features extraction process involves two types of information. The first type includes engineering specifications 115 that describe physical characteristics of the part. By processing these files the system can extract a set of physical features that describe the part. Examples of these features include material, e.g., which metal, height, width, and depth of the part, physical volume, number of cores, and characteristics of the drill holes. The second type of information involves machining specifications such as tolerances, smoothness, drill holes, drill hole volume, and parting line perimeter. There is a set of engineering specifications associated with each part. As a component the feature extraction process, the system processes each specification and extracts relevant information for cost modeling.

Second, using the data loading rules 175, the system transforms, normalizes and validates parts data as it is stored in the database 165. In one embodiment of the present disclosure, the data loading rules 175 are written in the R statistical language as well as the SQL programming language.

Third, the system employs exception reports 160 that highlight unusual and suspect information. The reports, for example, identify unusually expensive parts or cheap parts, parts with missing weights, parts with no demand, suppliers, and many other characteristics of the data.

Fourth, the system analyzes 2D parts drawings and 3D engineering models of the parts and extracts features that are predictive of costs. In one embodiment of the present disclosure, cost predictive features variables include financial information, purchasing information, and feature information. As shown in TABLE 1, the features may involve part characteristics such as the volume of the part, which along with the density of the material, is used to calculate the part's weight, number of holes drilled into the part, type of drill used, number of cores, number of risers, surfaces, machine setups, and the like. One of ordinary skill in the art will appreciate that this table does not provide an exhaustive list, but is merely illustrative. The features characteristics are the primary drivers that enable the system's predictive models to achieve high accuracy.

TABLE 1
Cost Predictive Features Variables

| Financial | Purchasing | Feature Information |
|---|---|---|
| Part Number | Segment | Material |

| | | |
|---|---|---|
| Part Name | Family | Aluminum |
| Engineering Change | Class | Brass |
| Forecasted Annual | Supplier | Ductile Iron |
| Demand Past 12 | Buyer | Gray Iron |
| Base Part Price | Finishes Status | Malleable Iron |

(Rough, Semi,

| | | |
|---|---|---|
| Additional Charges | Part Weight | Steel |

| | | |
|---|---|---|
| Packaging | Quoted Annual | Casting Cost |
| Painting | Quote Date | Part Dimensions |

| | Other | Height |
|---|---|---|
| | Material | Width |
| | Export Charges | Depth |
| Storage/ | | Surface Area |
| Warehousing | | |
| | Tooling | Part Volume |
| | Premium | Box Volume |
| | Charge | |

Finished Weight

Part Features

Cores
Core Volume
Pressure test - Air
Pressure test - Fuel
Pressure test - Oil
Pressure test - Water

Machining Cost

Direct

Ports
Port Volume
Drill Holes
Drill Hole Volume
Heat Treat
Parting Line
Perimeter Grinding
Machine Setups
Riser Removal
Surface Area
Flatness

Indirect

Forecasted Annual
Demand
Log Annual
Demand

Assembly Cost
Direct

Bearings
Fasteners
Seals

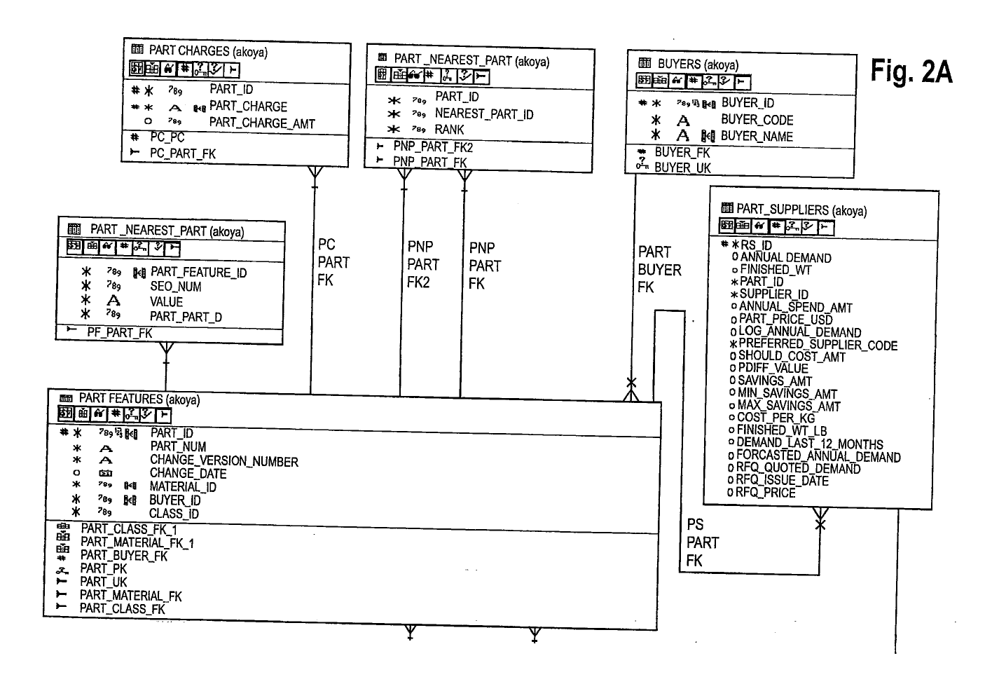

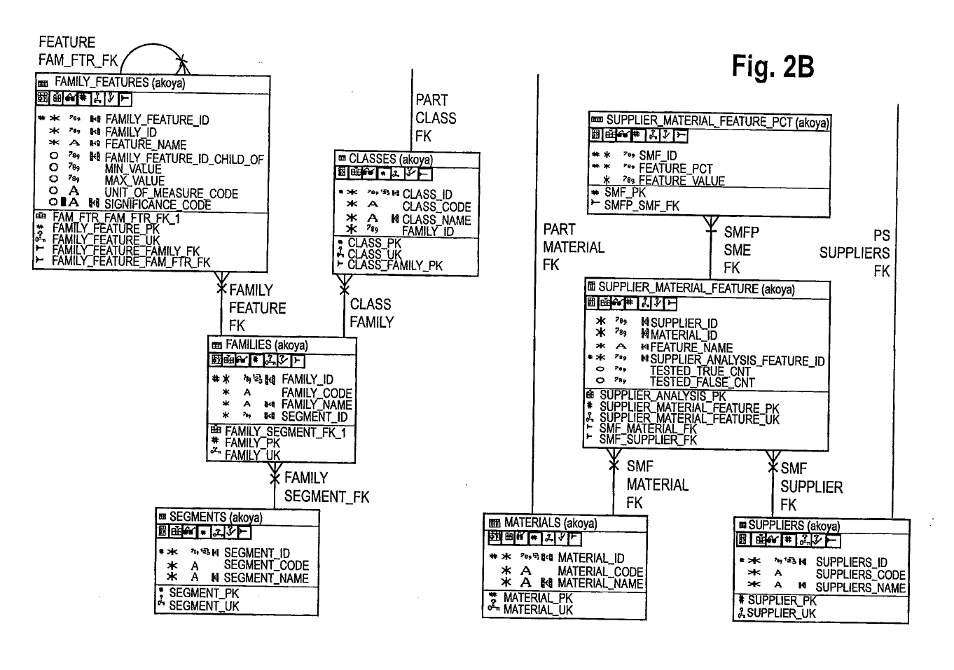

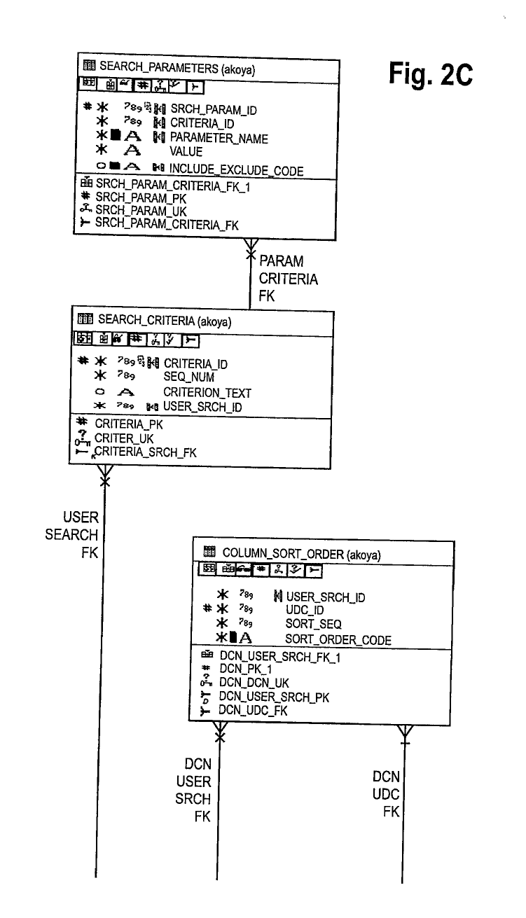

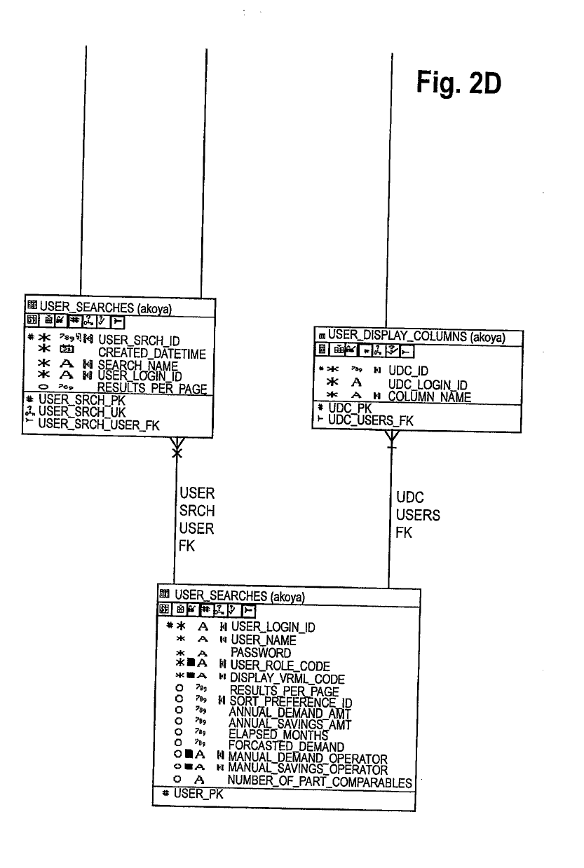

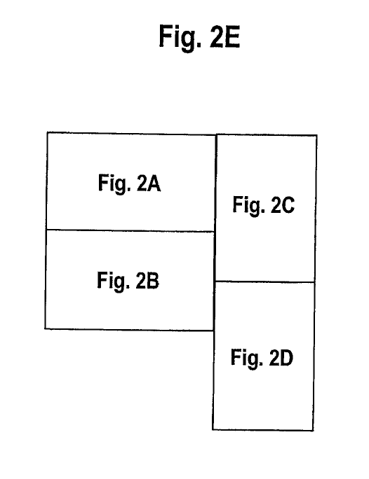

The fifth part of the system's data management layer is the database 165. In one embodiment of the present disclosure, the system organizes parts data using snowflake schema data warehouse model with fact tables for parts and suppliers. An exemplary embodiment of the snowflake database schema is shown in FIG. 2a-2e. One of ordinary skill in the art will appreciate the snowflake schema is but one architecture of a data warehouse, and other schemas, including but not limited to a star schema, may be used.

It should be appreciated that part of this disclosure relates to choices of variables which may be loaded and data loading rules 175 used to process the data. There are many possible features that can be extracted from CAD data and many possible purchasing and demand variables. One aspect of the disclosure is the selection of variables and modeling techniques that are predictive of cost.

### 1. Data Management Architecture

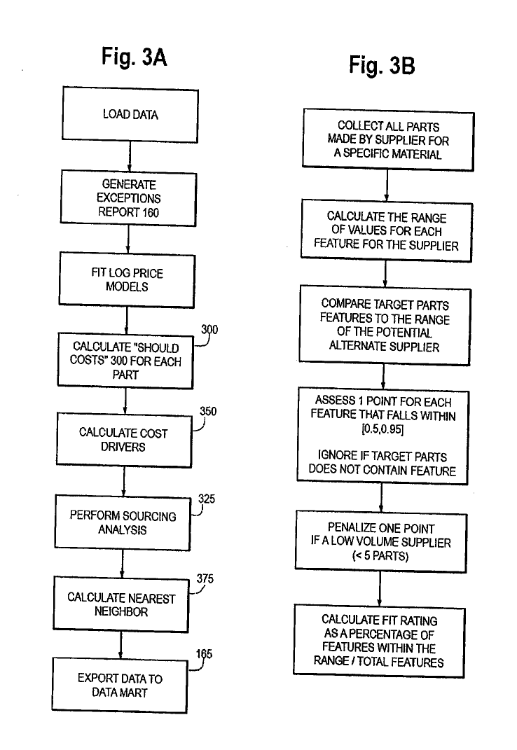

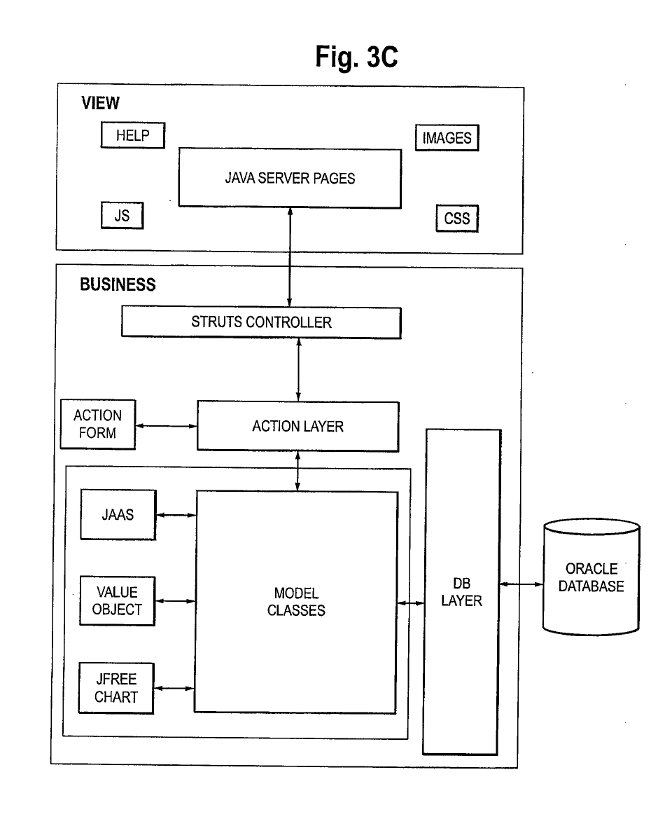

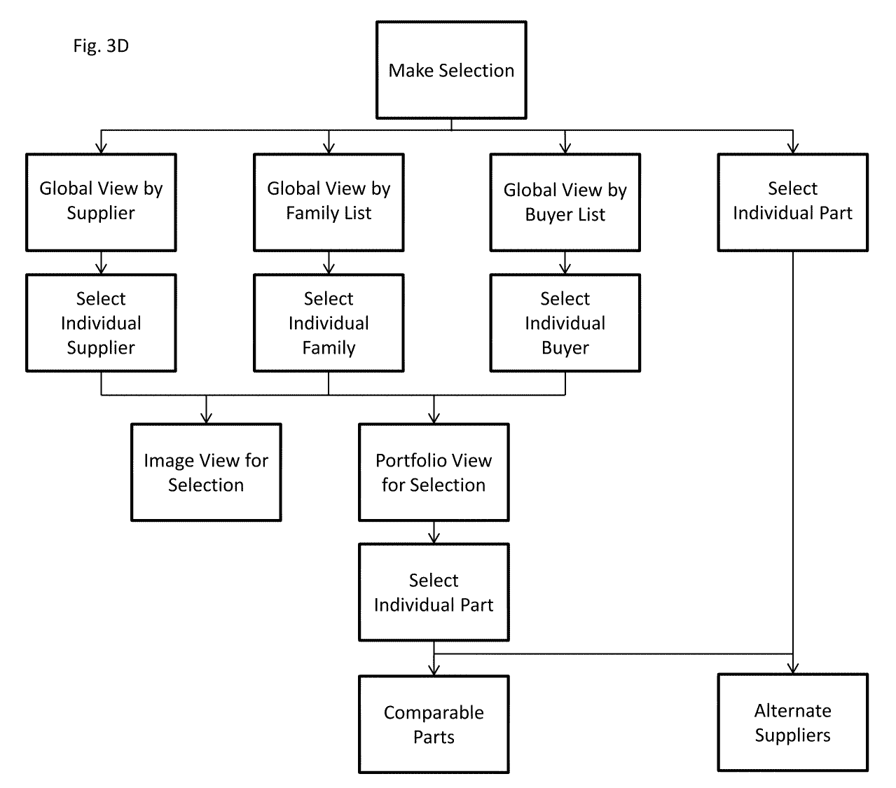

At the architectural level, in at least one embodiment of the present disclosure, the system performs data management functions using a four-step process, as shown in FIG. 3A. The data management process may be performed as follows: First, the system extracts the data from the customer delivered formats and loads the files into memory. Next, the system aggregates, categorizes and filters the data based on customer defined rules. At this point, the system performs extreme value elimination by applying the data loading rules 175 and looking for extreme statistical values. The parts associated with the extreme values are eliminated from the data set under consideration. The system then takes the data from step 2 and loads it into database 165 for analysis. If a part is excluded from loading, the system will generate exception reports 160 which provide the user with information on any data load failures or exceptions. Once the data is properly loaded into the database 165, the analytics layer 120 performs model fitting algorithm analysis.

### II. Analytics Layer

The second layer of the system's architecture is the analytics layer 125. The analytics layer 125 consists of a series of statistical routines that, in at least one embodiment of the present disclosure, are implemented using the R Statistical Language. Further, this analytics layer 125 may comprise two parts: an analytics module and an analytics architecture.

### A. ANALYTIC MODULES

As part of its analytical layer 125, in at least one embodiment of the present disclosure, the system performs four primary calculations. First, based on part features, material, manufacturing processes, and purchasing demand volumes, the should cost 300 module of the analytics layer 120 calculates a “should cost” price for each part. For purposes of illustration, “should cost” refers to the amount of money a part should reasonably cost in a global or regional market. The system can identify outlier parts by comparing the “should cost” with the vendor's quoted price. Outliers refer to parts which seem to be unusually expensive (or inexpensive) compared with what the system predicts that they should cost. Second, the cost drivers 350 module of the analytic layer 125 identifies key factors called “cost drivers,” which contribute to part costs. These key factors can be used by the engineering staff to minimize costs in the design process. Third, the nearest neighbor 375 module identifies similar parts called “nearest neighbors.” Last, the sourcing analysis 325 module of the analytics layer 125 analyzes the capabilities of the suppliers to identify their core capabilities (type of parts they make, supplier quality, supplier delivery, supplier pricing, and the like) and thereby determines which parts are most efficiently sourced with each respective supplier.

Should Cost—Predicting What Each Part should Reasonably Cost

The should cost 300 module models the costs of parts by predicting the price/mass (e.g., dollar/kg) for each part using generalized linear models.

a. Linear Combination Algorithm—Predicting the Price/kg

This algorithm predicts the log of the cost per kilogram of a part using a linear combination of features and categories. log(costperkg) transform(dmd)+finwt.kg*material+boxvol+height+width+depth+risers*material+drillholeComp*material+surfarea*material+partingLinePerim*material+factor(hasCores)+nCores+factor(nCores)+coreVol+sqrt(coreVol)+sqrt(nCores)+factor(nCores)+heatTreat+sqrt(pressTestAir)+sqrt(pressTestOil)+sqrt(pressTestWater)+sqrt(pressTestFuel)+sqrt(drillholes)*material+nPorts+factor(rsf)+class.desc+nBearings+nSeal+NFasteners)+factor (material)

What should be appreciated is that the model described herein does not predict “should cost” directly. Instead, for each family of parts, the algorithm predicts the log of cost per kilogram as a linear function of the log of the annual demand for parts, physical features of the part, machining costs, and engineering specifications. The type of material, which the model includes as a variable, is also important. The predicted “should cost” price is then the exponential of the predicted log cost per kilogram of the part.

In at least one embodiment of the present disclosure, models like that described above are developed for all of the parts together and then again for each family of parts (e.g., Bonnets, Brackets, Covers, Housings, Elbows, and Supports). After the full model is fit, the system refines such models using R's step procedure. In at least one embodiment of the present disclosure, step applies the stepAlC algorithm. In at least one embodiment of the present disclosure, the algorithm refines the model, adds and removes variables, and iterates until it finds the best fit. One skilled in the art will appreciate that other refinement procedures may be used and that the above described embodiment is not exclusive but merely illustrative.

### 1. Cost Drivers

In at least one embodiment of the present disclosure, the cost driver 350 module identifies outliers by comparing the “should cost” with the vendor's quoted price. After outliers are eliminated, in a similar calculation to “should cost,” the cost drivers for a family of parts are predicted using a linear combination of features and categories.

The system models the cost per kilogram of each part as:

Cost per kg finwt.kg(alum,duct,brass,iron,gray,steel)+boxvol+height+width+depth+risers+drillholes+drillHoleComp+surfarea+partingLinePerim+nCores+coreVol+heatTreat+factor(pressTestAir)+factor(pressTestWater)+factor(pressTestfuel)+factor(pressTestOil)+nBearings+nSeals+nFasteners+nPorts,+portVol,+flatness+log(demand)

What should be appreciated is that this model does not predict “cost drivers” directly. Instead, for each family of parts it predicts the cost per kilogram as a linear function of the log of the annual demand for parts, physical features of the part, machining costs, and engineering specifications. The type of material, which the model includes as an interaction term, is also a factor. The predicted “cost driver” price is then the exponential of the predicted log cost per kilogram of the part. In at least one embodiment of the present disclosure, models of this form are developed for all of the parts together and then again for each family of parts (e.g., Bonnets, Brackets, Covers, Housings, Elbows, and Supports).

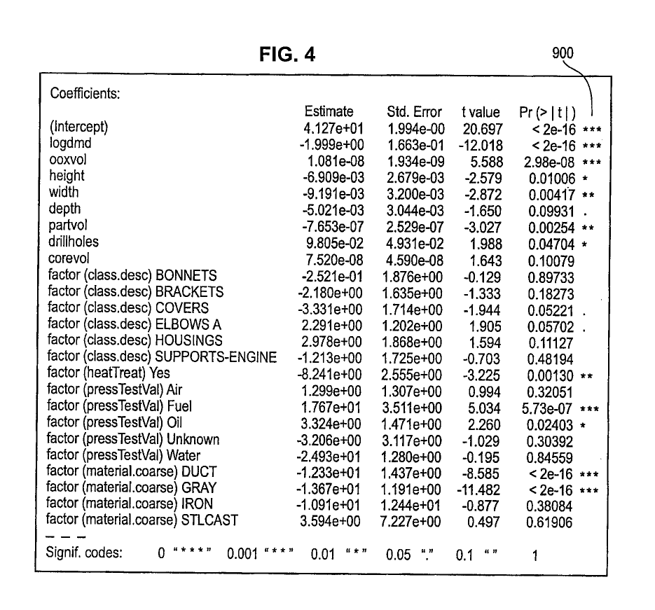

In at least one embodiment of the present disclosure, most predictive factors (cost drivers) and their relative effects are easy to interpret. FIG. 4 shows sample output from the system's Prediction Model. As illustrated in FIG. 4, certain key variables in the Model are marked with symbols, such as “***”, “**”, or “*”, to indicate their level of significance in the cost driver significance 900 column. In at least one embodiment of this particular model (model of a direct materials part analysis), the key variables for predicting costs include log (annual demand), box volume, part volume, drill holes, part type, material, and type of pressure test.

The relative effects of cost drivers for this example are shown in Table 2. The units in the table are incremental costs measured in cents per unit change in the cost driver. Thus, for example, on average a 10× increase in demand (log dmd) (1× in log scale) decreases the cost per kilogram of a part by $1.99.

TABLE 2
Cost Drivers and their relative effects in cents.

| Cost Drivers (CD) | Incremental costs (G/unit |
|---|---|
| Logdmd | −199.87 |
| Boxvol | 1.08 |
| Height | −.69 |
| Width | −.91 |
| Depth | −.50 |
| Partvol | −7.56e−5 |
| Drillholes | 9.80 |
| CoreVol | 7.54 |
| factor(class.desc)BONNETS | −24.20 |
| factor(class.desc)BRACKETS | −217.95 |
| factor(class.desc)COVERS | −333.12 |
| factor(class.desc)ELBOWS A | 229.05 |
| factor(class.desc)HOUSINGS | 297.75 |
| factor(class.desc)SUPPORTS- | −121.31 |
| factor(heatTreat)Yes | −824.10 |
| factor(pressTestVal)Air | 129.85 |
| factor(pressTestVal)Fuel | 1767.42 |
| factor(pressTestVal)Oil | 332.38 |
| factor(pressTestVal)Unknown | −320.61 |
| Factor(pressTestVal)Water | −24.93 |
| factor(material.coarse)DUCT | −1233.37 |
| factor(material.coarse)GRAY | −1366.98 |
| factor(material.coarse)IRON | −1090.80 |
| factor(material.coarse)STLCAST | −359.44 |

It should be appreciated from linear regression theory that the parameters in Table 2 are the cost drivers that are displayed as part of the output from the statistical modeling process. These parameters estimate the incremental costs for each of the features included in the model. In at least one embodiment of the present disclosure, these features are validated by applying the data loading 175 rules. It is sometimes the case that randomness in the statistical models results in aberrant estimates. The data loading 175 rules flag suspect values and provide explanations such as insufficient data in the case of extreme randomness.

### 2. Nearest Neighbor Algorithm—Identifying Similar Parts

The second class of system algorithms involves searching feature space to identify similar parts or nearest neighbors. In at least one embodiment of the present disclosure, calculation of data structures subsequently applied to produce predictions and used in the nearest neighbor analysis is performed at data loading time or whenever new data is added to the system's database. The system uses predetermined variables as feature vectors and defines these vectors as a point in feature space:

Vi=V1V2 . . . Vn

where Vi is the value of feature i for the particular part under consideration. TABLE 3 shows a list of variables used in one embodiment of the nearest neighbor analysis. One of ordinary skill in the art would appreciate that the table is meant to be only illustrative and not exclusive. The system then normalizes each of the numeric features using the standard 5 normal transform and in at least one embodiment of the present disclosure calculates the Euclidean distance (d) between the points representing the different parts in feature space. One of skill in the art will appreciate that other distance metrics, besides the Euclidean, may be used.

d(Vpart1fVpart2)=IIVpart1⁻Vpart2II

where 11 II is the standard Euclidean distance function. When the user selects a target part, pre-selected feature variables of that part become reference points and the system then provides the distance between those target variables and all other parts. The nearest neighbor algorithm constrains the match so that certain attributes of the parts must match exactly, e.g., the parts must be made of the same material and be the same part type. Within this restricted class it enumerates all distances and returns the n candidates to the user interface.

TABLE 3
Variables for Nearest Neighbor Analysis

| Comparable Analysis Variable | Comparable Analysis Variable Definition |
|---|---|
| Finwt | Finished weight |
| Height | height dimension |
| Width | width dimension |
| Depth | depth dimension |
| Partvol | part volume dimensions |
| Surfacea | surface area dimension |
| partingLinePerim | parting line perimeter grinding |
| Risers | risers (removal) |
| Drillholes | number of drill holes |
| nPorts | number of ports |
| HeatTreat | heat treat of part |
| PressTestAir | pressure test air |
| PressTestFuel | pressure test fuel |
| PressTestOil | pressure test oil |
| PressTestWater | pressure test water |
| nCores | number of cores |

### 3. Sourcing Analysis—Evaluating the Suppliers

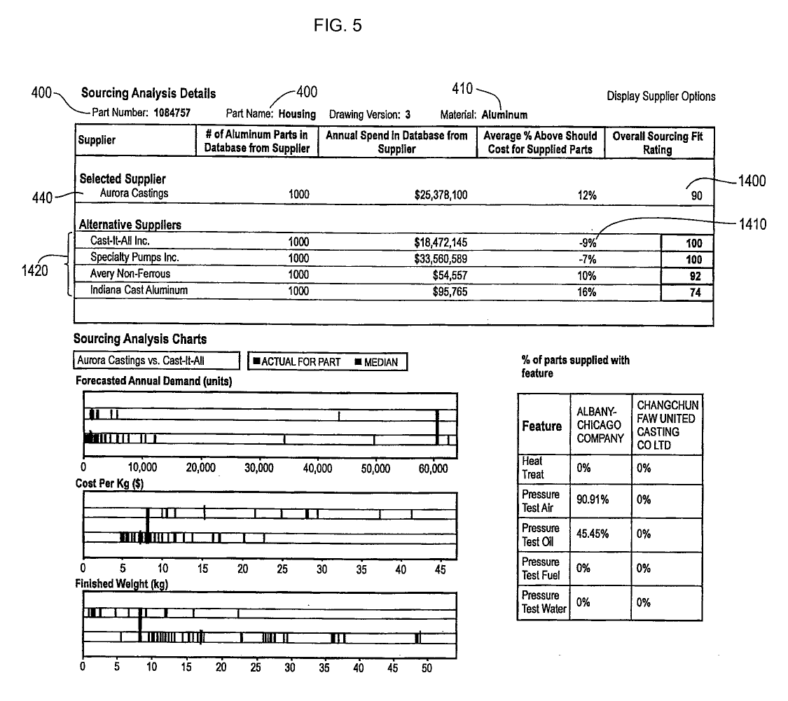

One possible reason for an overpriced part maybe because it is sourced with a supplier who cannot produce it efficiently. For each part, the system rates each supplier on an Overall Sourcing Fit Rating 1400, as shown in FIG. 5. An Overall Sourcing Fit Rating 1400 is calculated for each supplier by determining how far the target part is away from the range of efficiency for each supplier for each of the different part source variable categories, including but not limited to the variables listed in TABLE 4. One of ordinary skill in the art will appreciate that the table is meant to be only illustrative, and not exclusive. If the Overall Sourcing Fit Rating 1400 is low, it suggests that perhaps another source might be more appropriate for this part.

TABLE 4
FEATURE VARIABLES FOR OVERALL SOURCE FIT RATING
Feature Variables for Overall Sourcing Fit Rating

Cost per Kg
Annual Demand
Finwt/kg
Height
box volume
Surface area dimension heat treated
Pressure Testing
Air
Fuel
Oil
Water Average core volume Average port
volume Average drill hole volume
Maximum flatness is.assembly

The sourcing fit analysis works by analyzing the parts that each supplier produces, as shown in FIG. 3B. The first step in the calculation is to collect all parts made by supplier for a specific material. Next the system calculates the range of values for all part source categories for each part for each supplier. The system then compares the part source categories for the target parts features to the range of the source part values of each potential supplier. The system assesses 1 point for each feature that falls within [0.5,0.95]. If the target parts does not contain the feature, the system ignores it. Further, the system applies penalties in the case of a low volume supplier, poor supplier quality or poor supplier delivery. Using this scoring rating, the system calculates fit rating as a percentage of features within the range/total 10 features.

The score percentage displayed in the user interface is the Score(p)/number of features checked. For each part, the algorithm checks every possible supplier, sorts them in reverse order, and displays the best suppliers. Ties for suppliers that have the same percentage are broken by sorting on pdiff, the percentage difference between should cost and the actual price.

### B. ANALYTICS ARCHITECTURE

At the architectural level, in at least one embodiment of the present disclosure, the system performs system analysis, as shown in FIG. 3A.

Using all of the parts data in the system's populated database 165, in an off-line process, the system runs several statistical and data mining routines that fit models. The fitting process results in sets of models and coefficients that are used in subsequent analysis. In addition, the system pre-calculates data structures that are subsequently applied to produce predictions and used in the nearest neighbor 375 module.

As part of its off-line calculations, the system stores each part in the invention database for “cost reasonableness” and flags any unusual parts for further investigation. In at least one embodiment of the present disclosure, model fitting and scoring are performed at data loading time or whenever new data is added to the system's database 165. While the above description refers to the process being performed off-line, it should be noted that the process may be performed on-line, instead of off-line.

As shown in FIG. 3A, the system 10 analysis process may be performed as follows: Once the data is loaded into the database 165, as discussed above and shown in FIG. 3A, the system sequences the model fitting algorithms to ensure the proper fitting and results. Next, the system extracts data from the database 165 and loads that data into the analytical engine. The analytical engine then performs the following model fitting algorithms analysis based on input from the sequencer:

First, the system calculates the “should cost” price in the should cost 300 module. Here, for each part, in at least one embodiment of the present disclosure, the system applies the model from step 3 to predict the cost of each part. The predicted “should cost” value is compared with the vendor's price to identify large percentage differences, which one embodiment stores in a variable called pdiff. Parts with large positive pdiffs, e.g., parts that are much more expensive than predicted, are candidates for cost savings. Parts that are significantly less expensive than predicted may put the supplier at financial risk as they are not charging enough for the part. The should cost 300 module is described at length above.

Next, the system calculates “Cost Drivers” from the cost drivers 350 module. Here, for each part family, in at least one embodiment of the present disclosure, the system uses the R statistical language to fit multi-variate linear regression with complex interaction terms that predicts should cost as a generalized linear function of the part's features. As with normal statistical theory, the coefficients in this model are the relative contributions of the particular features. The “cost driver” 350 module is described at length above.

Next, the system performs the “Nearest Neighbor” analysis in the nearest neighbor 375 module. Here, in at least one embodiment of the present disclosure, for each part the system normalizes each feature to a (−1,1) scale and calculates the Euclidean distance between every part in feature space. Using this distance the system identifies the nearest parts and labels them neighbors. The nearest neighbor 375 module is described at length above.

Next, the system performs a Sourcing Analysis in the sourcing analysis 325 module. In at least one embodiment of the present disclosure, this analysis involves analyzing every part in the dataset that each supplier produces and calculating the [0.5, 0.95] range of each feature. Then, in at least one embodiment of the present disclosure, for each part, the system scores each supplier on 16 possible features and give the supplier points each time the part's feature is in the [0.5, 0.95] range of the supplier's capability. In an alternate embodiment, the sourcing analysis 325 module may score each supplier for an alternate number of features and give the supplier points in a manner described above. The system also subtracts points in case of a low volume supplier, poor quality or poor delivery performance. The rating of a supplier for a part is its total score/number of features evaluated. The calculation is performed by material for each supplier. The sourcing analysis 325 module is described at length above.

The last step involves pushing out the analytical results to a database 165. The Akoya website then accesses the database 165 to provide information to Akoya users. Users access the system's analytical routines, through the system's presentation layer, which is described below. A top level view of the Akoya application architecture, in at least one embodiment of the present disclosure, can be seen in FIG. 3C. For a description of the elements in the Akoya application, see LEGEND 1 below.

LEGEND 1: Elements in Akoya application Architecture

View
Akoya Applications
Business Intelligence Platform
Encapsulated Data Packages

### III. Business Intelligence Layer

The third layer of the system architecture is the business intelligence layer 130. The system's business intelligence layer 130 allows for the user to automatically group parts, suppliers, buyers, families, materials for analysis and provides a detailed analysis of cost saving opportunities.

A. Accessing the System

Users may access the system in several ways including: (i) selecting to analyze by supplier, (ii) selecting to analyze by buyer, (iii) analyzing a single part (iv) selecting to analyze by family. It should be noted that the system may be accessible through other ways such as by selecting a country, material, and/or other part features. One example of the logical flow of the business intelligence layer 130 is represented by FIG. 3D.

B. Supplier Management Application

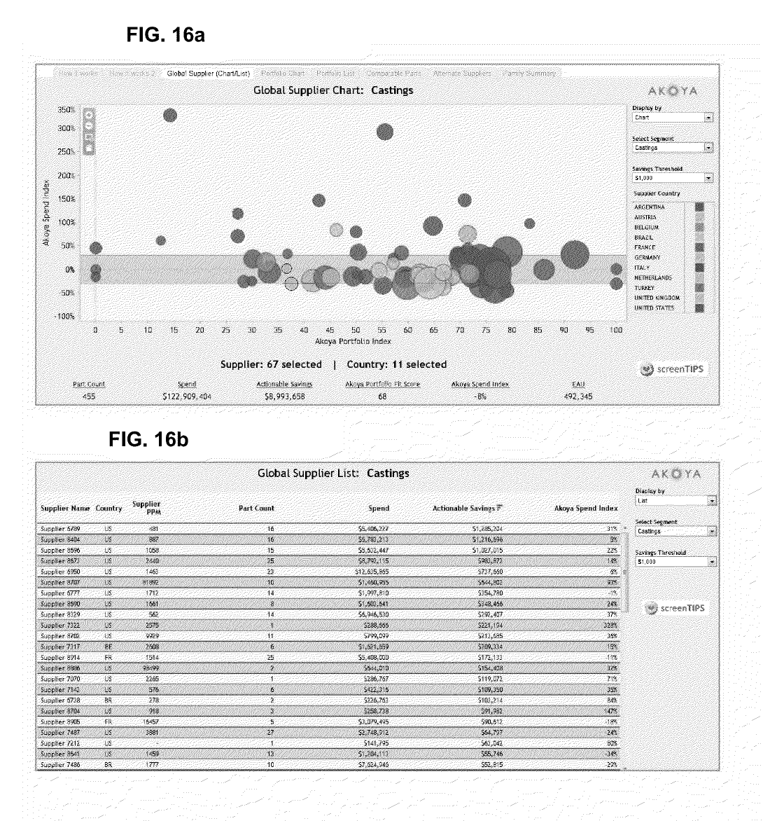

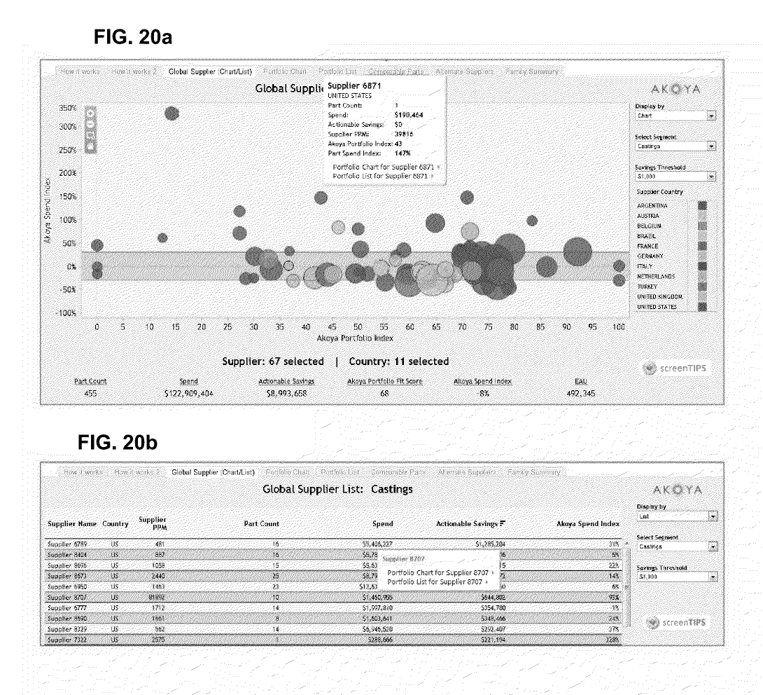

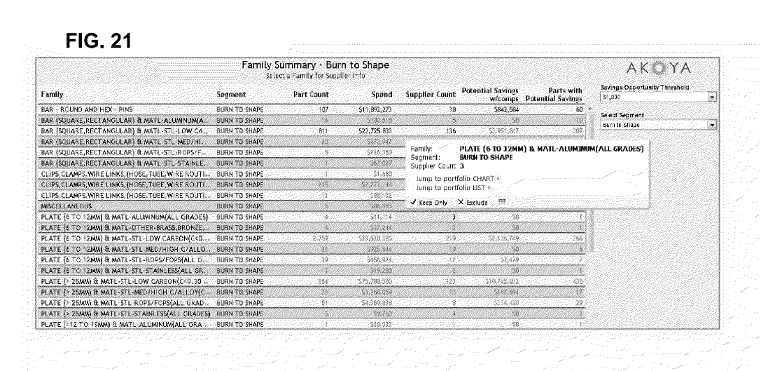

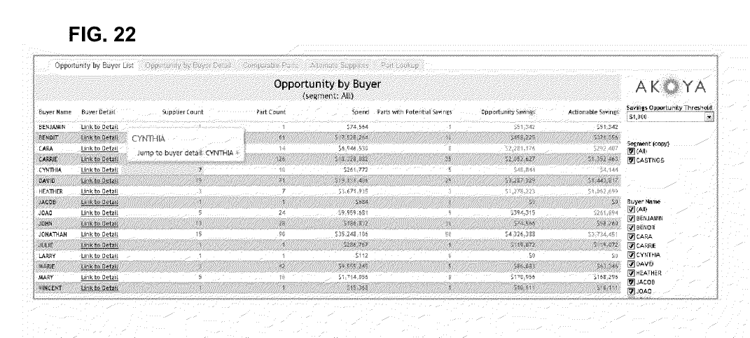

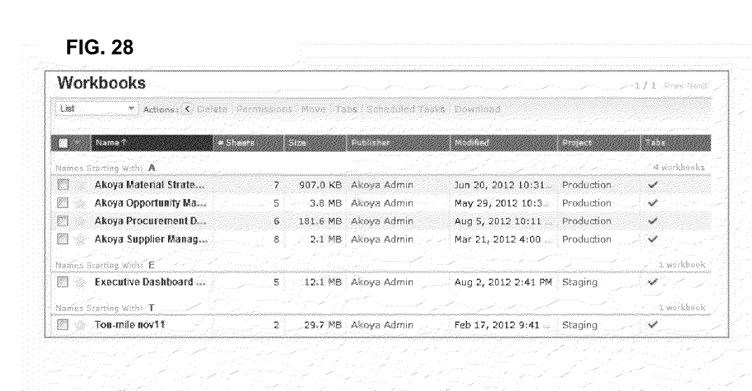

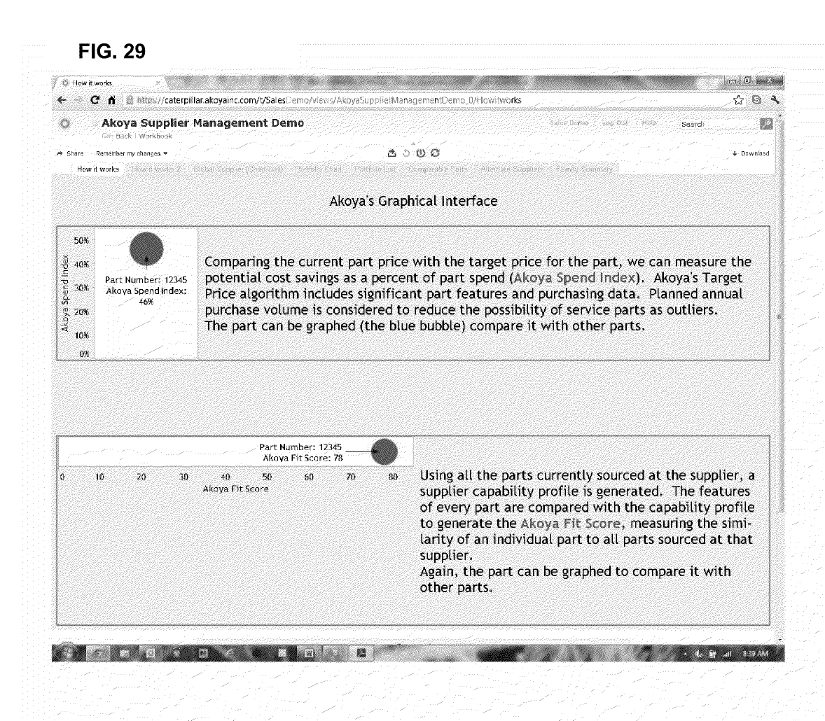

One way for the user to access the system is to select the Supplier Management Application link in FIG. 28. The system then displays the Global Supplier View (Chart FIGS. 16a and 16b). The Y axis represents the Akoya Spend Index. The Akoya Spend Index is the average of the spend weighted difference between the current part price and the Akoya should cost. For example, the Akoya Spend Index can be represented by the following equation: if ([Target Spend]=0 or sum([Price])=0) then 0 else [Spend]/[Target Spend]−1 end. The X Axis displays the Akoya Portfolio Fit Score (also described in this document as the Sourcing Fit Rating). The Akoya Portfolio Fit Score can be calculated using the following equation: Akoya Portfolio Fit Score=sum([Akoya Fit Score]*([Price]*[EAU]))/sum([Price]*[EAU]). The size of each bubble represents the spend with each supplier. FIGS. 29 and 20 describe in detail how this capability is used.

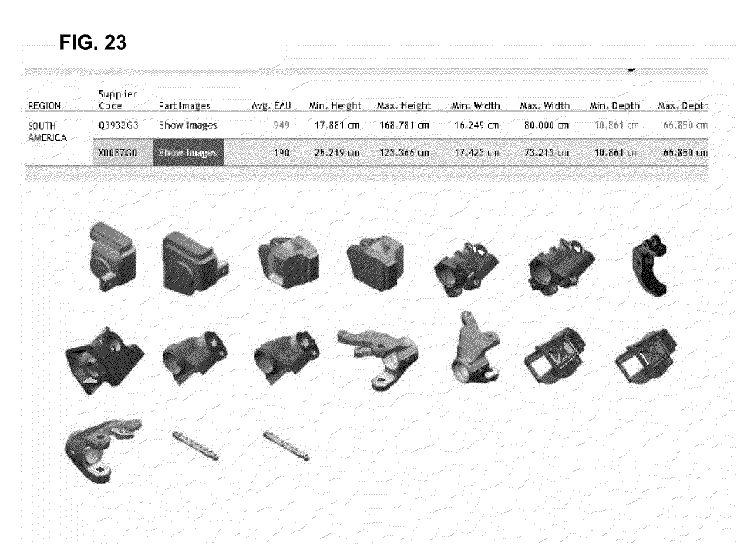

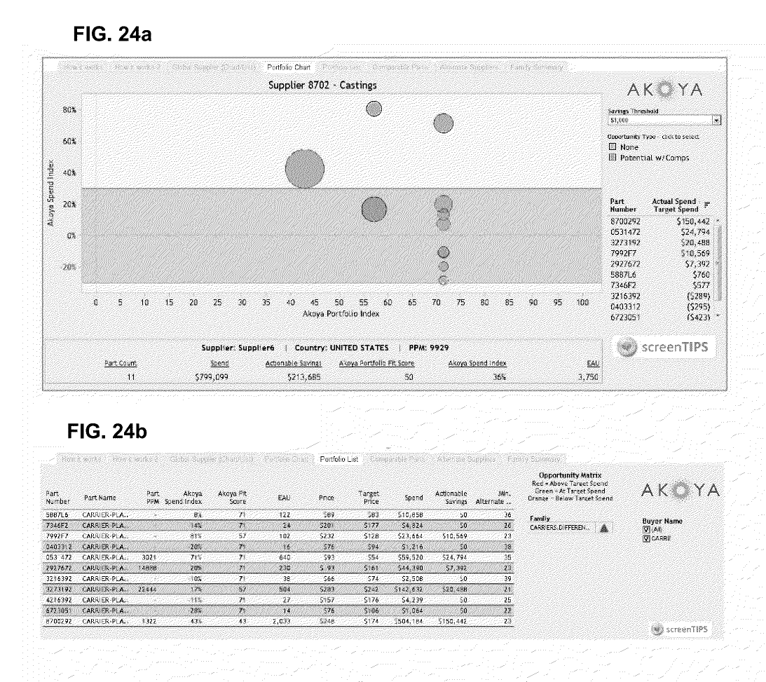

In at least one embodiment of the present disclosure, as shown in FIG. 20, the above-described entry point provides the user with the ability to drill down in the detailed portfolio of the selected supplier (FIGS. 24a and 24b). The user may also view the images for the selected part Portfolio (FIG. 23).

### C. FAMILY MANAGEMENT APPLICATION

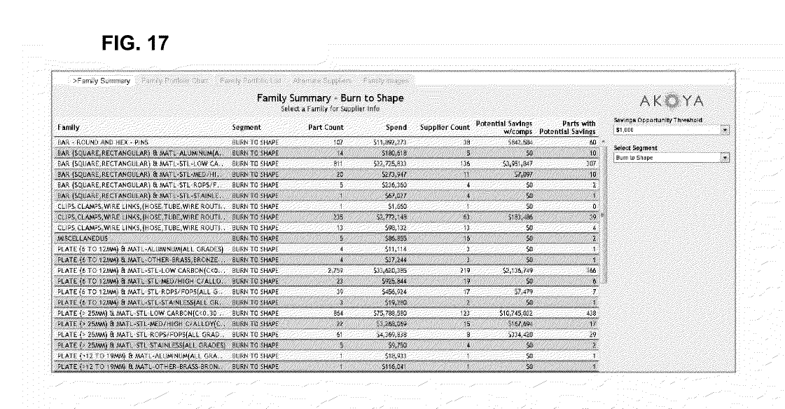

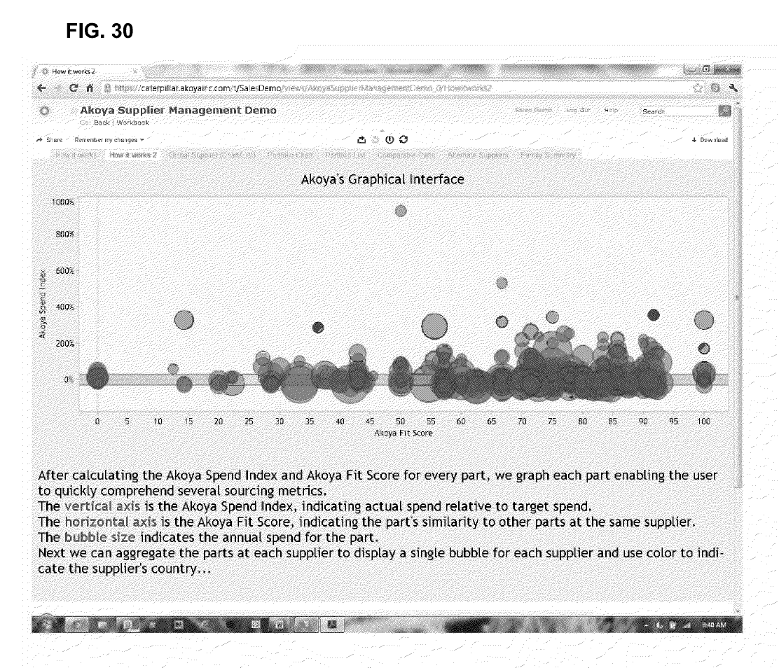

Another entry point to the system is to select the Family Management Application link. The system then displays the Global Family List (FIG. 17). The users can review the high level details for each family and determine which family they want to analyze. In at least one embodiment of the present disclosure, as shown in FIG. 30, the above-described entry point provides the user with the ability to drill down to the detailed portfolio of the selected family (FIGS. 24a and 24b). The user may also view the images for the selected part Portfolio (FIG. 23).

### D. OPPORTUNITY MANAGEMENT APPLICATION

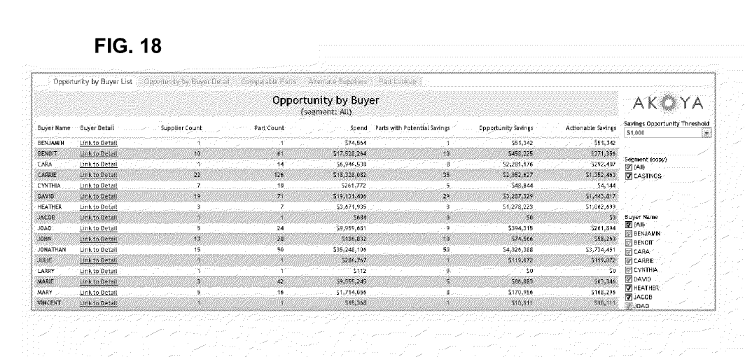

Another entry point to the system is to select the Opportunity Management Application link. The system then displays the Global Opportunity by Buyer List (FIG. 18). The users can review the high level details for each buyer and determine which buyer's portfolio they want to analyze.

In at least one embodiment of the present disclosure, as shown in FIG. 31, the above-described entry point provides the user with the ability to drill down in the detailed portfolio of the selected buyer (FIGS. 24a and 24b). The user may also view the images for the selected part Portfolio (FIG. 23).

### E. SINGLE PART ANALYSIS

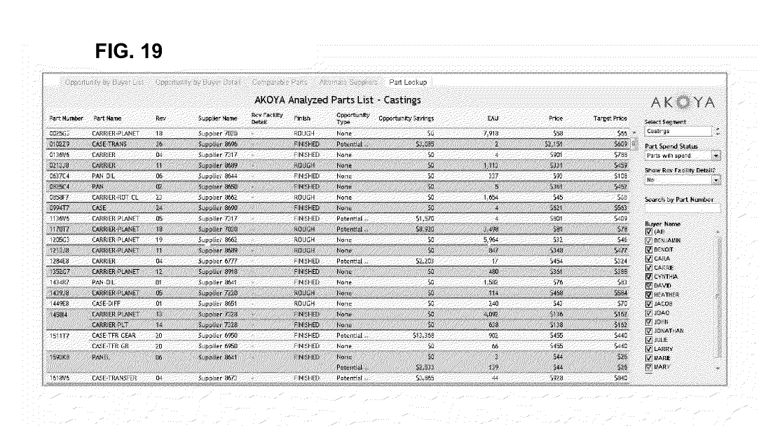

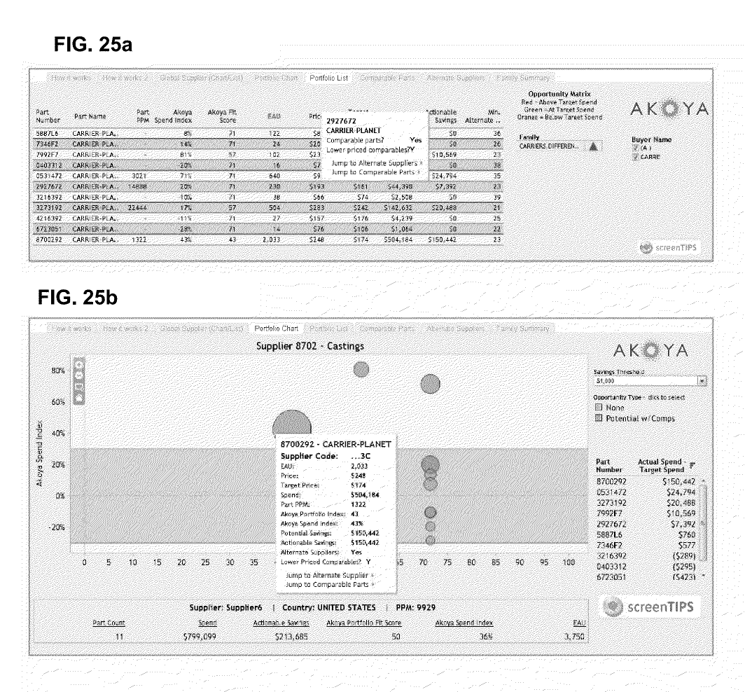

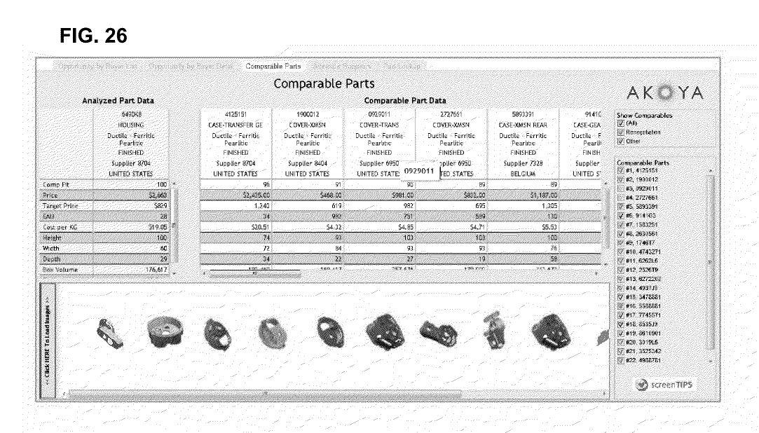

Another entry point to the system is to select the Part Lookup Application link. The system then displays the details for the selected part (FIGS. 19, 25a, and 25b).

### F. EXAMPLES

The following four examples describe a few of the ways the above applications can be used to solve industry problems.

### Example 1

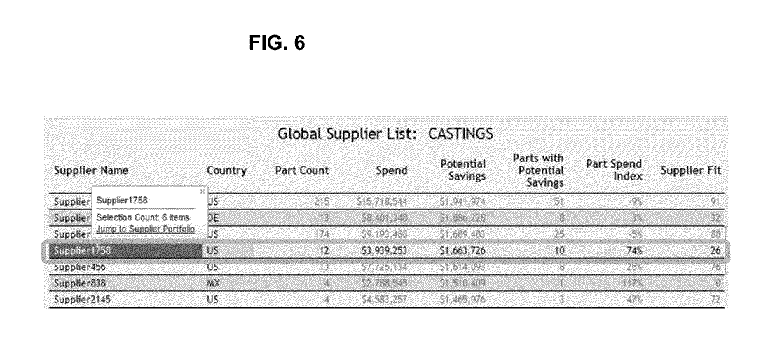

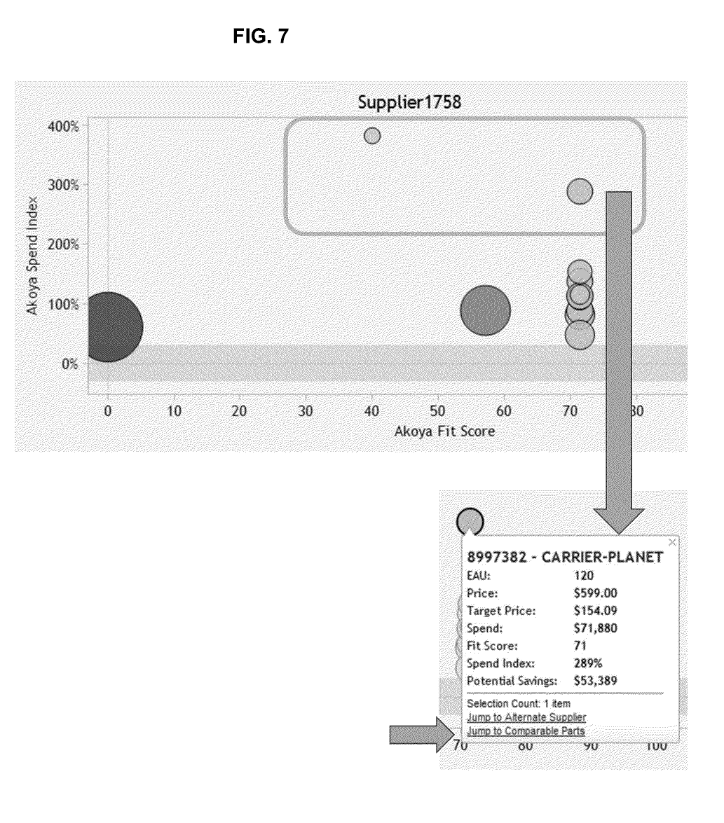

A purchasing manager for Company A conducts an annual review of one of Company A's supplier (for this example, Supplier 1758) to determine whether any money can be saved in the relationship with Supplier 1758. The purchasing manager enters the system by selecting a category of parts, namely castings, from a list. The purchasing manager then selects Supplier 1758 from the list of suppliers that provide castings to Company A. FIG. 6 illustrates a graphical user interface showing the list of suppliers that provide castings with Supplier 1758 highlighted and a pop-up box allowing the user to access additional information regarding Supplier 1758. As shown in FIG. 6, the list of suppliers includes columns for the supplier name, country where supplier sources the parts, part count (number of parts provided by supplier to Company A), the spend (amount Company A pays to supplier), potential savings (based on difference between should cost and supplier price), number of parts provided by supplier with potential savings, part spend index (average percent above should cost for supplied part), and supplier fit. By clicking on the Jump to Supplier Portfolio link in the pop-up box of FIG. 6, the purchasing manager is presented with the graph in FIG. 7, which shows the spend index versus the fit score for Supplier 1758. In FIG. 7, a circle represents a particular casting provided by Supplier 1758 and the diameter of each circle corresponds to the number of such castings purchased by Company A. For example, the greater the number of castings sold, the greater the diameter of the circle on the graph that represents such casting type. Such a visual representation of a part category allows a user to quickly identify significant categories of a supplier. As shown in FIG. 7, two of the casting types have a high spend index and appear to be significantly overpriced. In FIG. 7, one of the two overpriced casting types has been clicked on by the purchasing manager causing a pop-up box to be displayed. The pop-up box in FIG. 7 shows detailed information regarding the casting part represented by the selected circle, which has been clicked. As shown in FIG. 7, the pop-up box also includes two links: (1) Jump to Alternate Supplier and (2) Jump to Comparable Parts.

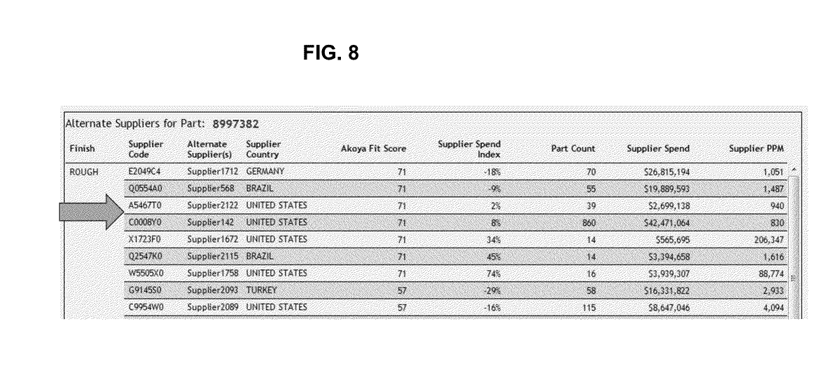

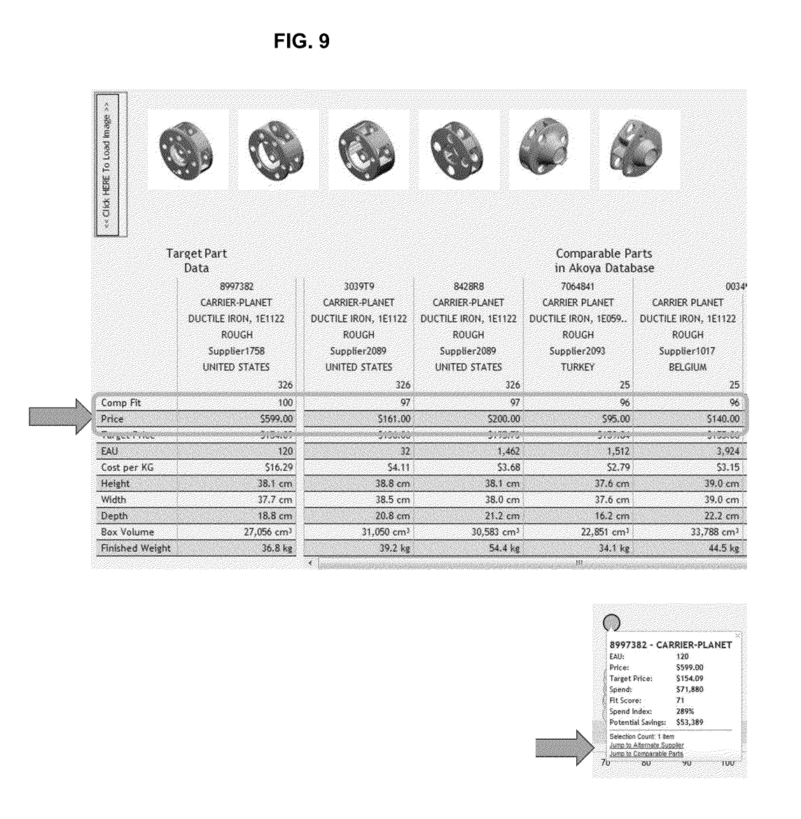

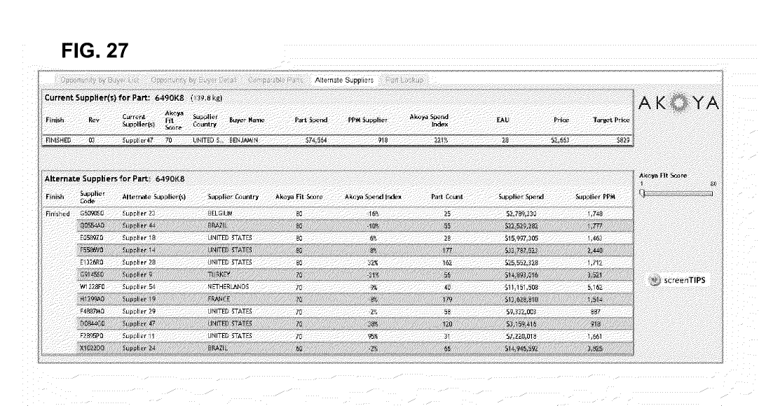

As shown in FIG. 8, when the Jump to Alternate Supplier link is selected by the purchasing manager, a list of suppliers for the particular casting part (namely, Part 8997382) is automatically displayed. As shown in FIG. 8, the list of suppliers includes supplier identification information, country of supplier, fit score, supplier spend index, and the like. (FIG. 27 shows a different example of a graphical user interface relating to Alternate Suppliers). By automatically identifying alternative suppliers in FIG. 8, the purchasing agent is able to quickly determine that there are several suppliers that have equivalent fit scores but substantially lower spend indexes. In other words, through use of the system, the purchasing agent can identify cost savings with alternative suppliers. As shown in FIG. 9, when the Jump to Comparable Parts link is selected by the purchasing manager, a chart of parts that are comparable to the particular casting part being examined (namely, Part 8997382) is automatically displayed. The comparable parts may be automatically determined based upon the nearest neighbor determination discussed above. As shown in FIG. 9, the chart of comparable parts includes details regarding each part, including price, height, width, depth, volume, and the like. (FIG. 35 shows a different example of a graphical user interface relating to Comparable Parts.) By automatically identifying comparable parts in FIG. 9, the purchasing agent is able to accurately determine an alternative part for the currently purchased part. Thus, the automatic display of alternative suppliers and comparable parts by the system allows a user of the system (in this case, purchasing manager), to quickly and accurately identify cost savings.

### Example 2

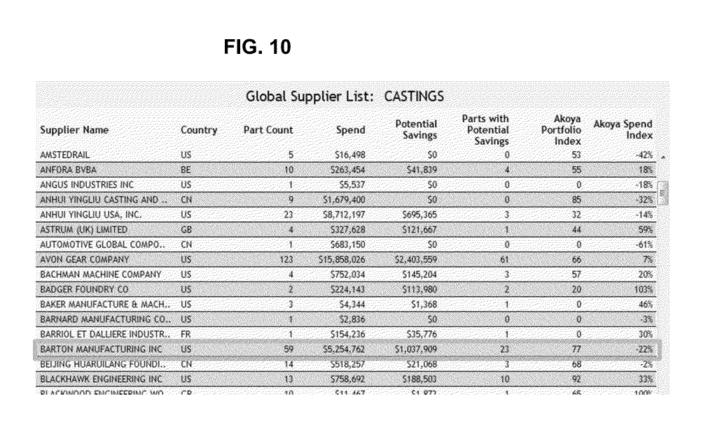

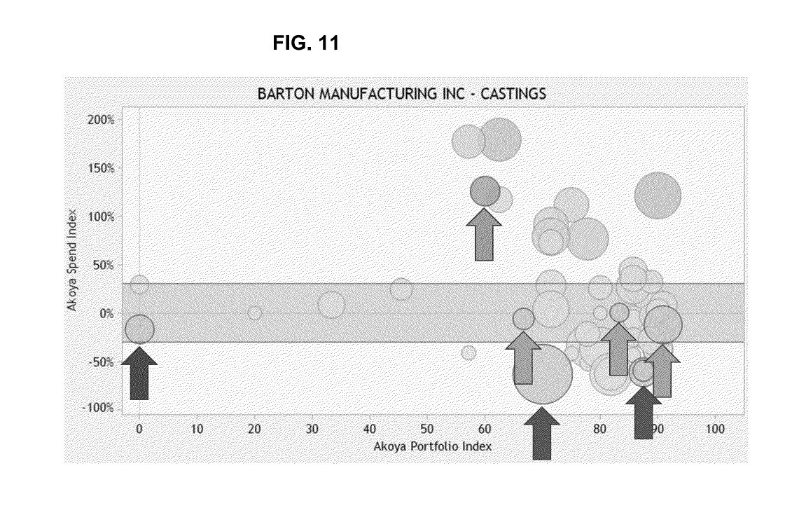

A key supplier of parts to Company A (Barton Manufacturing) asks for a price increase on a group of parts. In order to determine how to handle this proposed price increase, a purchasing manager for Company A enters the system by selecting the supplier (Barton Manufacturing). FIG. 10 shows an example of a list of suppliers upon which the purchasing manager may choose a particular supplier to analyze. In FIG. 10, Barton Manufacturing is highlighted in the list of suppliers. By clicking on this entry for Barton Manufacturing in the list, the purchasing manager causes the system to automatically produce a graph (FIG. 11) showing the spend index versus the portfolio index for all of the casting parts supplied by Barton Manufacturing. In FIG. 11, the graph shows casting parts of Barton Manufacturing represented by circles. The circles (representing casting parts) that are above the target price band in FIG. 11 are overpriced while those circles (representing casting parts) below the target price band are underpriced. Those circles in or near the should cost zone (shaded area) are where Company A believes the parts should be priced. Those circles on or near the Y-axis are parts that are not a good physical match to Company A's part needs, while those circles near the 100 mark along the X-axis are considered to be good physical matches to Company A's part needs. By automatically displaying a graph of spend index versus portfolio index for parts of a Barton Manufacturing in FIG. 11, the purchasing manager is able to and accurately determine whether a supplier should be given an price increase for a part by determining whether that part falls within (or near) the should cost zone and the availability of cost savings from alternative parts and suppliers.

### Example 3

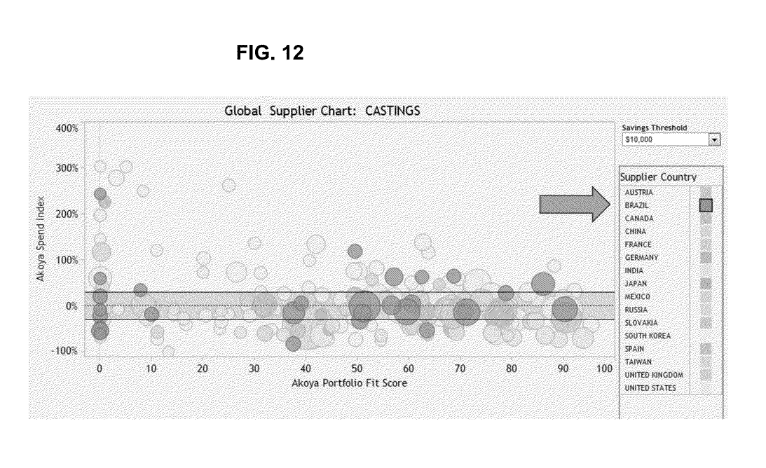

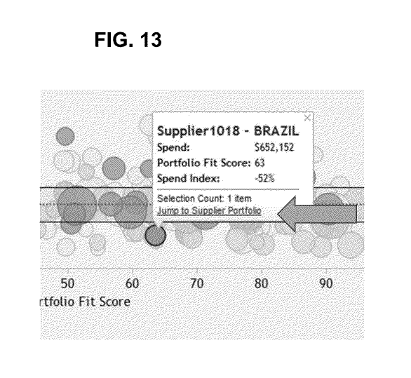

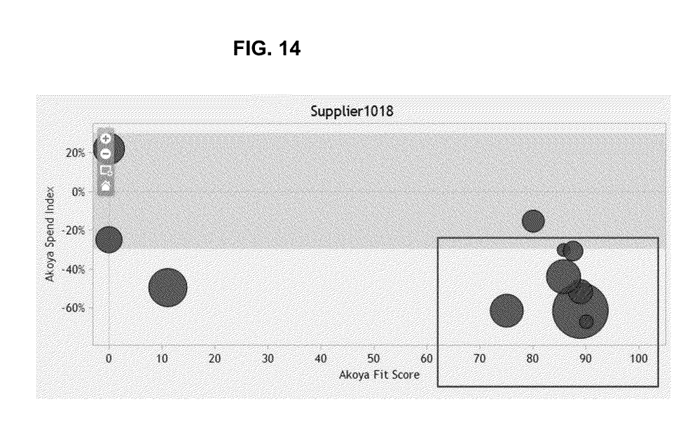

The VP of Purchasing at Company A asks all of Company A's purchasers to identify any at-risk suppliers. Purchaser AB (a purchaser for Company A) is responsible for all Brazilian casting suppliers for Company A. Purchaser AB enters the system by selecting the part category (castings). FIG. 12 shows a graph of casting parts purchased by Company A. Purchaser AB can select a particular country and the system automatically identifies which castings on the graph come from that particular country. For example, in FIG. 12, Purchaser AB has selected Brazil and the corresponding casting parts sourced from Brazil have been highlighted. By looking at the graph in FIG. 12, Purchaser AB is able to quickly and accurately identify suppliers that have spend indexes which are significantly below the spend indexes of other suppliers. Such suppliers with low spend indexes may be considered at-risk suppliers because the price they are selling their parts at is too low to be sustainable. Consequently, the user may decide to use the system further to determine whether the suppliers should be replaced. FIG. 13 shows a pop-up box that may be displayed when Purchaser AB selects a circle on the graph that represents a supplier. As shown in FIG. 13, the pop-up box shows detailed information regarding the supplier represented by the selected circle and also the link “Jump to Supplier Portfolio.” As shown in FIG. 14, when the “Jump to Supplier Portfolio” link is selected by the Purchaser AB, a graph of parts offered by the particular supplier (here, Supplier1018) is displayed. By automatically displaying a graph of spend index versus portfolio index for parts of a supplier in FIG. 13, Purchaser AB is able to quickly and accurately determine whether a supplier is at-risk for default and what alternative suppliers are available.

### Example 4

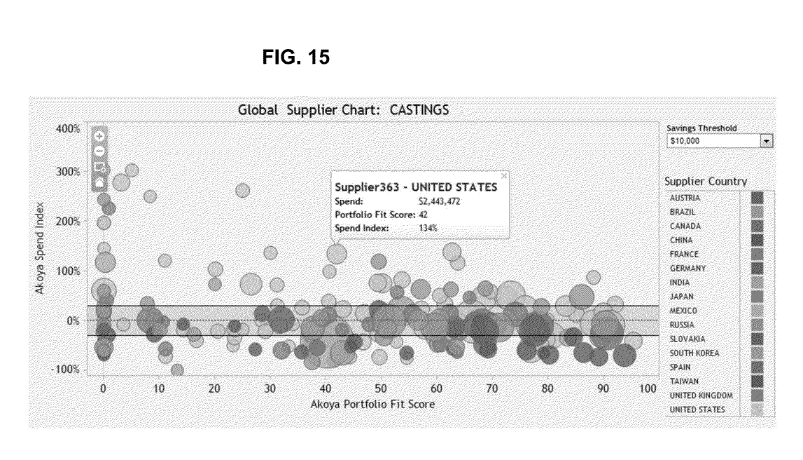

A procurement manager for Company A asks Purchaser AB to identify suppliers of Company A that are overcharging for their parts. Purchaser AB enters the system by selecting a category of parts, namely castings, from a displayed list. As shown in FIG. 15, the system displays all suppliers of Company A for the selected category of parts (castings). In FIG. 15, the circle representing Supplier 363 has been selected (or the cursor has been placed over the circle) resulting in a pop-up box being presented. The pop-up box includes detailed information about Supplier 363, namely spend, portfolio fit score, and spend index. As described above, any supplier with a spend index above 0% is over charging. As shown in FIG. 15, Purchaser AB can set the spend index threshold at a certain value (in this case, $10,000). The graph in FIG. 15 identifies the region above and below 0% spend index (shaded area) that falls within this threshold. By automatically displaying a graph of spend index versus portfolio index for parts of a supplier in FIG. 15, Purchaser AB is able to quickly and accurately determine whether a supplier is overcharging for a particular part.

### CONCLUSION

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

We claim:

1. A computerized method of automated feature-based analysis for cost management of direct materials comprising the steps of:
a) receiving a plurality of suppliers and at least one part offered by each of the plurality of suppliers;
b) determining, with a processor, a should cost for each of the at least one parts based at least in part on features characteristics information, financial information, and purchasing demand information;
c) receiving a request to compare the should cost for each of the at least one parts with a vendor price provided by a first supplier, wherein the first supplier is one of the plurality of suppliers;
d) determining, with a processor, a spend index and fit score for each of the at least one parts offered by the first supplier; and
e) automatically displaying a comparison of the spend index and fit score for each of the at least one parts offered by the first supplier through a graphical user interface.

2. The method of claim 1, further comprising the steps of:
f) receiving a request to provide alternative suppliers for each of the at least one parts of the first supplier; and
g) determining, with a processor, a list of alternative suppliers from the plurality of suppliers for each of the at least one parts; and
h) automatically displaying the list of alternative suppliers through the graphical user interface.

3. The method of claim 2, wherein determining the list of alternative suppliers is based at least in part on a fit score and supplier spend index of each of the plurality of suppliers.

4. The method of claim 2, wherein displaying the list of alternative suppliers includes displaying a supplier identification information and country of supplier for each of the suppliers in the list.

5. The method of claim 1, wherein the should cost is determined based at least in part on an annual demand for each of the plurality of parts, physical features of each of the plurality of parts, matching costs, and engineering specifications.

6. The method of claim 1, wherein the spend index is an average of a weighted difference between the vendor price and the should cost.

7. The method of claim 1, wherein the graphical user interface is a browser or tablet interface.

8. A computerized method of optimizing cost for parts offered by one or more suppliers, the method comprising:
receiving a vendor price for each of a plurality of parts offered by a plurality of suppliers;
determining, with a processor, a should cost for each of the plurality of parts, wherein the should cost is determined based at least in part on an annual demand for each of the plurality of parts, physical features of each of the plurality of parts, machining costs, and engineering specifications; and
determining, with the processor, a spend index for each of the plurality of parts, wherein the spend index is the average of a weighted difference between the corresponding vendor price and the corresponding should cost.

9. The method of claim 8, further comprising displaying the spend index through a graphical user interface.

10. The method of claim 9, wherein the displaying step includes a graph comparing the spend index for each of the plurality of suppliers.

11. The method of claim 8, wherein the spend index is calculated for one supplier of the plurality of suppliers.

12. The method of claim 11, further comprising:
determining, with the processor, at least one alternative supplier from the plurality of suppliers based on the at least one alternative supplier having a smaller spend index than the one supplier.

13. A system of optimized cost for parts offered by one or more suppliers, the method comprising:
a first interface, the first interface configured to receive a vendor price for each of a plurality of parts offered by a plurality of suppliers; and
a processor, the processor configured to determine a should cost for each of the plurality of parts, wherein the should cost is determined based at least in part on an annual demand for each of the plurality of parts, physical features of each of the plurality of parts, machining costs, and engineering specifications;
wherein the processor is further configured to determine a spend index for each of the plurality of parts, wherein the spend index is the average of a weighted difference between the corresponding vendor price and the corresponding should cost.

14. The system of claim 13, further comprising:
a graphical user interface, the graphical user interface configured to display the spend index.

15. The system of claim 14, wherein the processor is further configured to determine at least one alternative supplier from the plurality of suppliers based on the at least one alternative supplier having a smaller spend index than the one supplier.

16. The system of claim 15, wherein the graphical user interface is configured to display the at least one alternative supplier.

17. The system of claim 14, wherein the graphical user interface is a browser or tablet application.

18. A non-transitory computer-readable medium, said computer-readable medium containing computer executable code, said computer executable code configured to optimize cost for parts offered by one or more suppliers to a method comprising the steps of:
receiving a vendor price for each of a plurality of parts offered by a plurality of suppliers;
determining, with a processor, a should cost for each of the plurality of parts, wherein the should cost is determined based at least in part on an annual demand for each of the plurality of parts, physical features of each of the plurality of parts, machining costs, and engineering specifications; and
determining, with the processor, a spend index for each of the plurality of parts, wherein the spend index is the average of a weighted difference between the corresponding vendor price and the corresponding should cost.
